(19) United States
(12) Patent Application Publication
(10) Pub. No.: US 2010/0101563 A1
(43) Pub. Date: Apr. 29, 2010

(54) ABSORBER FOR SOLAR HEATING AND METHOD FOR PRODUCING AN ABSORBER

(75) Inventor: Werner Fischer, Dinslaken (DE)

Correspondence Address: Gregory A. Nelson;Novak Druce & Quigg LLP, 525 Okeechobee Blvd, Suite 1500, West Palm Beach, FL, 33401, US

(73) Assignee: ETA 86 Solar Steel AG, BAAR (CH)

(21) Appl. No.: 12/531,985

(22) PCT Filed: Mar. 18, 2008
(86) PCT No.: PCT/EP08/53213

§ 371 Date: Sep. 18, 2009

(30) Foreign Application Priority Data
Mar. 20, 2007 (DE) 102007013919.7

(51) Int. Cl. F24J 2/24; B23P 15/26

(52) U.S. Cl. 126/651; 29/890.033

(57) ABSTRACT

The invention relates to an absorber (10), which can be used to produce heat by means of solar heating, the absorber comprising an upper metal sheet (12) facing the sun and a lower metal sheet (14) facing away from the sun, between which sheets conducting means (18, 54) are provided for the substantially linear and/or homogeneous conduction of a fluid from an inlet (20) to an outlet (24). The inlet (20) and/or the outlet (24) and/or the conducting means (18, 54) are formed by the upper metal sheet (12) and/or the lower metal sheet (14), wherein the inlet (20) and/or the outlet (24) and/or the conducting means (18, 54) can be produced by deep-drawing, thereby resulting in a particularly simple and cost-effective production of the absorber (10).

The invention relates to an absorber, by means of which heat can be obtained by solar heating, for example in order to heat or to cool a building. The invention relates, furthermore, to a method for producing an absorber of this type.

In a known absorber which is used for the recovery of heat from solar heating, a copper plate is provided, onto which copper pipes are soldered or welded. The soldered-on copper pipes are connected on one side to a delivery pipe and on the other side to a discharge pipe. Water is conducted via the delivery pipe through the copper pipes, is heated in the copper pipes via heat radiation from the sun and can be used further, for example for heating, via the discharge pipe.

The disadvantage of an absorber of this type is the high outlay in production terms. The soldering of the copper pipes to the copper plate is time-consuming and is not always possible with a constant quality. Furthermore, it is necessary, in the case of the delivery pipe and of the discharge pipe, to make junctions by machining, for example by drilling, milling and/or welding, in order to connect the individual copper pipes to the delivery pipe and to the discharge pipe. To produce the absorber, therefore, several different work steps are required which have to be carried out with the aid of different machines and different processes. This is time-consuming and personnel-intensive, thus resulting in high production costs.

The object of the invention is to provide an absorber which can be produced more simply and a method for the simpler production of an absorber of this type.

The object is achieved, according to the invention, by means of an absorber having the features of claim 1 and a method having the features of claim 10. Advantageous refinements of the invention are specified in the subclaims.

The absorber according to the invention for the recovery of heat and/or energy from solar heating has an upper plate, which faces the sun when the absorber is in the operating state, and a lower plate, which faces away from the sun when the heat exchanger is in the operating state. Between the upper plate and the lower plate are formed conduction means, for example ducts or flow guide plates, through which a fluid can be conducted essentially linearly and/or homogeneously from an inlet to an outlet. The inlet and/or the outlet are/is formed by the upper plate and/or by the lower plate. The inlet and/or the outlet and/or the conduction means are capable of being produced by deep drawing.

It is thus possible to produce the absorber with the aid of very few components. The upper plate and lower plate, as individual components, and an intermediate plate, provided if appropriate, for forming the conduction means can be produced by means of comparable methods, so that large series of the individual components can be produced particularly simply and cost-effectively on an industrial scale. For example, it is possible to produce the upper plate, the lower plate and the intermediate plate from a metal strip, in particular one and the same metal strip, in that the individual plates are brought into their required shape by means of forming techniques, such as, for example, deep drawing, cold forming, hot forming and the like. Owing to the structural variations occurring in the plate, for example, during deep drawing, the strength and stability are increased, even in the case of a decreasing plate thickness, so that a durable product having a long useful life is obtained, using only a small amount of material. Depending on the application, various metal strips may also be used according to the application. As a result, it is possible, according to use, to combine various materials, plate thicknesses, coatings and shapes with one another, in that corresponding different metal strips are employed. This manufacture may take place, in particular, continuously and on an industrial scale. Furthermore, relatively few machines are required in order to produce the absorber according to the invention. The production of the absorber manages with comparatively cost-effective materials and additives. Production is therefore simplified and, not least, is more cost-effective because of the lower personnel costs, the particularly high cycle times during production and the cost-effective materials used. By means of a suitable selection of materials and their connection, the performance of the absorber can be optimized with regard to energy absorption and energy emission. In particular, the absorber has only exactly one inlet and only exactly one outlet.

Preferably, the inlet and/or the outlet are/is (a) simple protuberance(s), thus affording a simple geometry which can easily be produced by deep drawing. The protuberances may have a cylindrical or slightly conical configuration with a pitch of approximately 1.5% to 3.0% and, if appropriate, may have an undercut, so that it is particularly simple to connect a hose with the aid of a sleeve. The protuberances have, in particular, a particularly short configuration and, for example, a length which is just sufficient to connect a sleeve, so that, even in the case of particularly low plate thicknesses, the protuberances can be produced by deep drawing, and a welding of the inlet and of the outlet to the upper plate and/or lower plate can be avoided.

Furthermore, it is possible, by means of computer-assisted calculations, for example by FEM, to calculate for the absorber the ideal flow and energy absorption, for example on the basis of the materials, shape and/or coating. Correspondingly, the ideal energy discharge can be determined completely, even in the run-up, for example, on the basis of flow conditions in the absorber which are optimized for the respective application, with the result that the set-up and the geometry of the absorber can be ideally optimized even in the planning and design phase, so as to achieve optimal energy absorption and energy discharge by means of optimal flows in the absorber. Technical boundary conditions can be taken into account even at a very early stage and be implemented in such a way that a tailored optimized solution is obtained for each individual case.

On account of the relatively simple set-up of the absorber, and when correspondingly corrosion-resistant components are used, the absorber is virtually inspection-free throughout its useful life, since repairs of wearing parts are not necessary. The absorber is therefore particularly suitable for heating and/or cooling private buildings, since, in particular, maintenance activities, in so far as they are necessary at all, can, if required, be dealt with in a simple way by an outside contractor, and specific specialized knowledge is not required for operation.

In particular, it is possible to avoid copper or copper alloys as a material for producing the absorber. The absorber may preferably be produced from a steel or a nonferrous metal, with the exception of copper or copper alloys. It is therefore possible to select particularly cost-effective material or to use a material which can be brought into the desired state in a particularly simple way by means of the forming methods provided.

The conduction means may be formed, for example, by a shaped intermediate plate which has been shaped, in particular, by forming. The shaped intermediate plate is designed, for example, as a corrugated plate or trapezoidal plate. However, the conduction means may also be produced in that the upper plate and/or the lower plate are shaped, in particular by forming, in such a way that the conduction means are formed, for example, as ducts between the upper plate and the lower plate. For this purpose, the conduction means may, in particular, be formed by deep drawing of the upper plate and/or of the lower plate.

Preferably, the conduction means are formed in one piece with the lower plate and the upper plate bears on the conduction means. Additionally or alternatively, the conduction means are formed in one piece with the upper plate and the lower plate bears on the conduction means. Preferably, all the conduction means are formed either only by the upper plate or only by the lower plate, in order to keep the outlay in production terms low. In particular, the plate having the formed conduction means may be configured in such a way that all the contact faces are located in one common plane, so that the other plate can be configured as a straight panel which does not have to be formed. Since in each case the other plate bears on the formed conduction means, external forces, for example the dead weight of the upper plate, and internal forces, for example the pressure of the fluid in the absorber, can be absorbed and discharged more effectively. This makes it possible to have an absorber with a large surface, without problems in terms of statics occurring.

Particularly preferably, a plurality of conduction means are provided which are arranged, spaced apart from one another, in the flow direction and/or transversely to the flow direction. In this case, use is made of the knowledge that the fluid has such a low flow velocity that a plurality of conduction means arranged individually are sufficient to ensure a linear flow from the inlet side to the outlet side which, in particular, is laminar. In particular, the conduction means are contoured fluidically in the flow direction, in that the conduction means have, for example, a wedge-shaped or drop-shaped cross section. Preferably, the conduction elements have a length in the flow direction which is greater than a width transversely to the flow direction. The conduction means can thereby ensure an essentially linearly flowing fluid flow and, at the same time, offer particularly low flow resistance.

In a preferred embodiment, the lower plate has an entry basin, assigned to the inlet, for forming an inflow region. Furthermore, the lower plate has an exit basin, assigned to the outlet, for forming an outflow region. The entry basin and the exit basin are connected via a conduction bottom which, if appropriate, forms the conduction means projecting out of the plane of the lower plate. The conduction bottom is in this case at a shorter distance from the upper plate than an entry basin bottom of the entry basin and an exit basin bottom of the exit basin. In the inflow region, the flow of the fluid which has been conducted via the inlet into the entry basin can initially be equalized somewhat on account of the markedly falling flow velocity, with the result that turbulent or nonuniform flows in the region of the conduction bottom are avoided, or at least the degree of turbulence is reduced. Correspondingly, in the outflow region, the flows flowing past the conduction elements are first converged before the fluid leaves the absorber via the outlet. As a result, turbulent flows are avoided, or at least reduced, even in the outflow region and in the region of the conduction bottom.

In particular, it is possible to ensure the equalization of the flow only through the basins, so that a linear, in particular laminar, and homogeneous flow can be achieved in the region of the conduction bottom, without further aids. In this case, the fluidic action of the conduction means formed in the region of the conduction bottom may have an essentially assisting effect, so that the conduction means, instead, assume a stabilizing action for the structural set-up of the absorber. Moreover, if the absorber has sufficient stability, the conduction means arranged in the region of the conduction bottom may even be omitted. The linear and/or homogeneous flow achieved by means of the basins may in this case be provided in the region of the conduction bottom between straight faces of the lower plate and of the upper plate, in order to absorb and/or emit heat. The conduction means for the essentially linear and/or homogeneous conduction of the fluid through from the inlet to the outlet are in this case formed solely by the entry basin and/or the exit basin.

The entry basin in the inflow region and the exit basin in the outflow region are dimensioned, in particular, as a function of the expected volume flow of fluid. Since a largely uniform, in particular laminar and homogeneous flow is therefore obtained within the absorber, heat transport in the flow direction is optimized or is at least reduced opposite to the flow direction, so that, by means of the absorber according to the invention, a particularly high temperature difference of the fluid between the inlet and the outlet can be achieved, with the result that the efficiency of the absorber is improved. In particular, a homogeneous temperature distribution arises in the flow direction which, in particular, is laminar. Furthermore, particularly in the case of production by deep drawing, the flow cross section provided in the inflow region may be larger than the flow cross section in the outflow region, so that a change in the flow velocity can be implemented from the inlet to the outlet, for example in order to optimize the energy absorption or energy discharge for particularly high efficiency. It is thus possible that, in the inflow region and/or in the outflow region, the flow cross section, which is determined by the distance of the upper plate from the lower plate, is configured larger than in the region of the conduction bottom. The inflow region and/or the outflow region can thereby assume a storage function and store part of the fluid temporarily in the inflow region and/or in the outflow region.

The distance of the conduction bottom from the upper plate amounts, in particular, to ≧1.5 mm to ≦6.0 mm, preferably ≧2.0 mm to ≦4.0 mm and, particularly preferably, to ≧2.5 mm to ≦3.5 mm. The average flow velocity of the fluid, in particular water, amounts in the region of the conduction bottom, in particular, to ≧0.001 m/s to ≦0.02 m/s, preferably ≧0.002 m/s to ≦0.005 m/s and, particularly preferably, ≧0.0025 m/s to ≦0.0035 m/s. As a result, high heat absorption can be achieved, while at the same time a particularly low pressure loss is achieved.

In a preferred embodiment, the upper plate and the lower plate are connected to one another, for example, by means of adhesive bonding or laser welding. Preferably, for this purpose, the upper plate and the lower plate have in each case an at least partially peripheral extension or flange, so that the upper plate and the lower plate can be connected to one another via the extension/flange. The intermediate plate, present if appropriate, may likewise be connected to the upper plate and/or the lower plate, for example, by means of adhesive bonding or laser welding. If, in particular, a ferritic steel is used for the upper plate and the lower plate, the hysteresis losses of the steel can be utilized, in that the steel is heated by induction in order to cure rapidly the adhesive used, so that the production rate rises and a setting-aside of the absorber for curing the adhesive, if at all, can be at least reduced. However, it is also possible to clamp the intermediate plate fixedly in terms of movement between the upper plate and the lower plate by connecting the upper plate to the lower plate, so that there is no need for a separate connection of the intermediate plate to the upper plate and/or to the lower plate. Additionally or alternatively, the individual connections between the upper plate, lower plate and/or intermediate plate may take place positively, for example by snapping. For this purpose, for example, an undercut rib can be inserted, in particular fixedly in terms of movement, into a depression tapering in the opening region, the rib and/or the depression being capable of being produced by forming, in particular deep drawing.

Preferably, during operation, the absorber is fastened to a carrier in the region of the peripheral extension/flange. Particularly preferably, the absorber has a fastening device, in which a holding groove is provided. The peripheral extension can be inserted into the holding groove, so that the absorber is held reliably in the fastening device. An at least partial destruction of the surface of the plates used for the absorber, for example in order to provide through bores for fastening screws by holing, is thereby avoided. The fastening device may, in particular, surround the absorber in a frame-like manner, preferably in the region of the peripheral extension, and insulate said absorber with respect to the building. Particularly preferably, the fastening device has a top side which is in alignment with the upper plate. Since the top side of the fastening device is in alignment with the upper plate, the absorber gives the overall impression of being essentially smooth. This essentially planar design makes it possible to attach the absorber to a building in a visually pleasing way. For example, the absorber can be mounted on a roof of a building, without the appearance of the building being appreciably impaired. The fastening device in this case at the same time allows insulated mounting on the building. Preferably, the absorber is mounted by means of the fastening device at a height such that, between the lower plate and the ground, a gap is obtained which is large enough to receive delivery lines connected to the inlet and/or to the outlet. The delivery pipes therefore cannot be seen from outside, so that the overall visual impression is not impaired. Furthermore, the delivery lines are protected, for example, from rainwater.

In particular, it is possible to provide in the lower plate and/or in the upper plate a viewing region which is preferably of essentially transparent design. For this purpose, for example by stamping, a recess can be provided in the upper plate and/or in the lower plate, preferably both the upper plate and the lower plate having the recess, and the recesses being arranged essentially one above the other, in order to provide a window which allows a view through the absorber. The recesses may be closed by means of a suitable material, for example acrylic glass and/or silica glass. It is possible, by means of the viewing region, to check the state of the absorber on the inside. Furthermore, a viewing window may be formed, so that the absorber can also be arranged in the region of a building window, without the view out of the building being significantly impaired. It is also possible to provide in the viewing region a photovoltaic element for generating electrical energy from sunlight, for example a solar cell. This makes it possible by means of the absorber to provide both heat and electrical energy, without in this case producing CO₂.

Particularly preferably, the upper plate is coated at least partially with an absorption layer for the absorption of solar radiation. The absorption layer may, for example, be a special absorption lacquer having a particularly high absorbency for sunlight or else a lacquer in a dark color, for example black. As a result of the improved absorption of solar radiation, the heating of the fluid conducted through the absorber can be improved, with the result that the efficiency is improved. Additionally or alternatively, the upper plate, the lower plate and/or the intermediate plate may be provided on the top side and/or on the under side with a coating which, in particular, provides corrosion protection. This ensures the useful life of the absorber, while at the same time maintenance is simplified, since, in particular, there is essentially no need for inspections. Particularly when the individual plates are connected to one another by means of adhesive bonding or positive connections, such as, for example, snapping, damage to the coatings is avoided, thus ensuring reliable corrosion protection and, at the same time, a reliable connection of the plate components.

The lower plate is, in particular, capable, as a load-bearing component, of absorbing at least the dead weight of the absorber, without in this case being bent. For this purpose, the lower plate has a plate thickness of, in particular, ≧0.1 mm to ≦2.5 mm, preferably ≧0.5 mm to ≦2 mm, and, particularly preferably, ≧0.7 mm to ≦1.5 mm.

The upper plate of the absorber according to the invention may have a particularly small plate thickness, with the result that the weight of the absorber is reduced and the forming of the upper plate is simplified. The upper plate has, in particular, a plate thickness of ≧0.05 mm to ≦1.2 mm, preferably ≦1.0 mm or ≦0.4 mm, and, particularly preferably, ≦0.2 mm.

The invention relates, furthermore, to a solar heating segment, by means of which a fluid, for example water or an emulsion, can be heated with the aid of solar radiation. The solar heating segment has a fastening device with a plurality of fastening rails, for example comparably to a glass façade. The fastening rails of the fastening device surround an absorber for the recovery of heat from solar heating essentially in a frame-like manner. The absorber may be designed and developed, as described above. On account of the essentially frame-like fastening device, a plurality of solar heating segments, each having an absorber, can be arranged, preferably next to one another, in such a way that they afford a larger area which is used for heating the fluid. In particular, a plurality of solar heating segments may be connected in series, in order to achieve a particularly high temperature rise of the fluid to be conducted. Furthermore, a plurality of solar heating segments or accumulations of series-connected solar heating segments may be connected in parallel, in order to increase the mass flow of the heated fluid.

The invention relates, furthermore, to a solar heating plant, in which a fluid is heated with the aid of solar radiation. This solar heating plant has a plurality of solar heating segments which may be designed and developed, as described above. In the solar heating plant, the individual solar heating segments are connected to one another, at least in a part region, via the same fastening rail. That is to say, the fastening rail of a fastening device of a first solar heating segment is at the same time part of a fastening device of a second solar heating segment. It is thereby possible to reduce the area required for receiving the individual absorbers, so that a particularly large amount of area can be provided for the absorbers and a particularly small amount of area can be provided for the fastening device.

The invention relates, furthermore, to a building which has a plurality of solar heating segments and/or a solar heating plant, which in each case may be designed and developed, as described above. On account of the stable type of construction, the plurality of solar heating segments and/or the solar heating plant form at least partially a roof and/or a wall of the building. The solar heating segments or the solar heating plant are therefore not only placed, for example, onto roof tiles of the roof, but also replace the roof tile covering otherwise required. The solar heating segments or the solar heating plant can therefore be placed directly onto the roof substructure, which is partially the supporting framework for the solar heating segments, and connected to this.

The invention relates, furthermore, to a method for producing an absorber which, in particular, may be designed and developed, as is described above. In the method, a first sheet bar and a second sheet bar are provided, which have been obtained, in particular, beforehand preferably by stamping out of one common flat strip which, in particular, is in the form of a coil. The first sheet bar is deep-drawn to form an upper plate and/or the second sheet bar is deep-drawn to form a lower plate, during deep drawing an inlet and/or outlet and/or conduction means being formed in the upper plate and/or in the lower plate. In particular, preferably at the same time, an entry basin assigned to the inlet and an exit basin assigned to the outlet are produced by deep drawing. If appropriate, the inlet and/or the outlet and/or the resulting flange surface are trimmed. The upper plate is connected to the lower plate, in particular, by adhesive bonding and/or snapping, in order to form the absorber. By means of this method, the production of the absorber, which can be used as an absorber for solar heating, is simplified. For production, it is necessary merely to have machines which are known, for example, with the know-how required for these, from automobile technology, for example, building construction. In particular, it is possible in each case to subject the upper plate and the lower plate to a forming method at most once only. All deep-drawing operations can be carried out in a single step, in particular further forming steps not taking place.

The invention is explained in more detail below by means of preferred exemplary embodiments, with reference to the accompanying drawings in which:

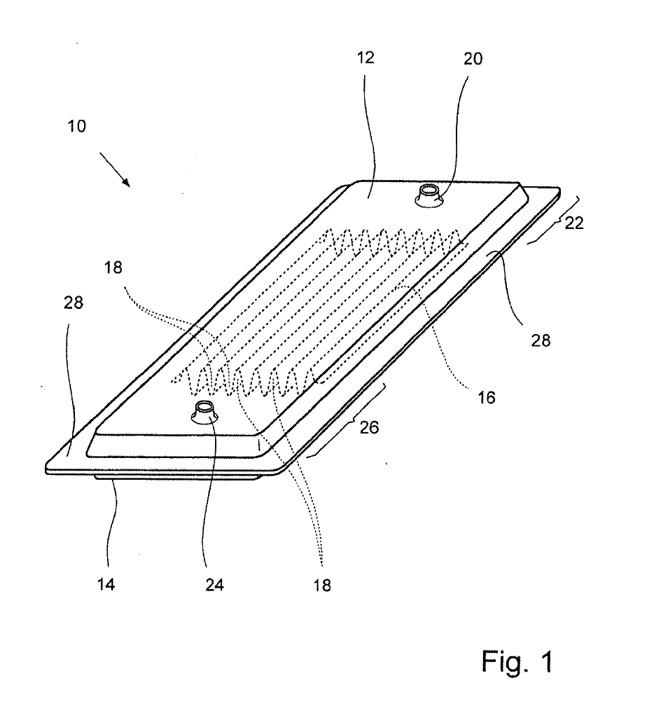

FIG. 1 shows a diagrammatic perspective view of an absorber according to the invention,

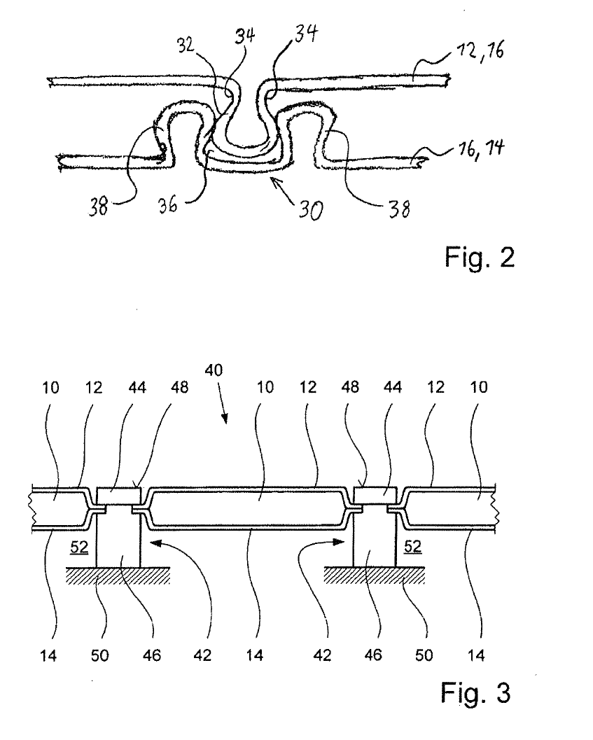

FIG. 2 shows a diagrammatic side view of a connection point of the absorber according to the invention,

FIG. 3 shows a diagrammatic sectional view of a solar heating plant which has absorbers according to the invention,

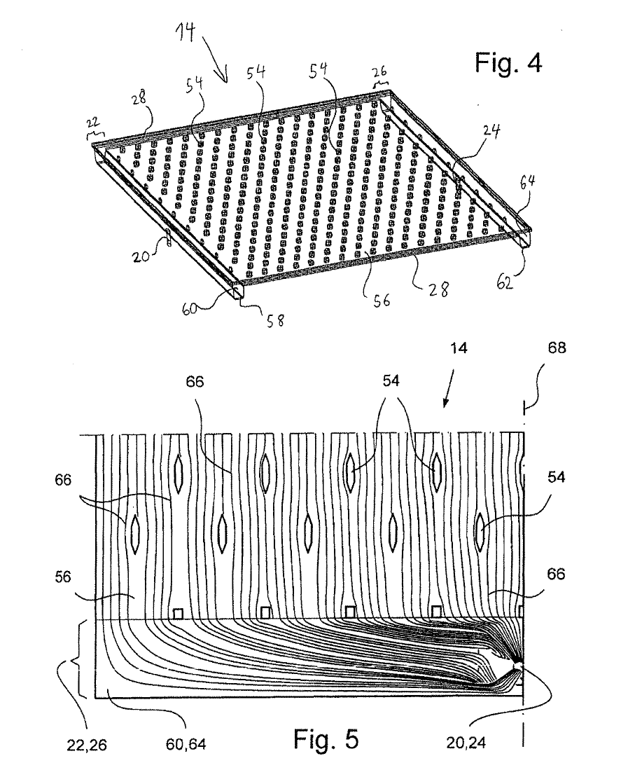

FIG. 4 shows a diagrammatic perspective view of a lower plate for the absorber according to the invention, and

FIG. 5 shows a diagrammatic top view of the lower plate from FIG. 4 with flow lines.

The absorber 10 according to the invention has an upper plate 12 facing the sun in the operating state and a lower plate 14 facing away from the sun. In the example illustrated, an intermediate plate 16 configured as the corrugated plate is arranged between the upper plate 12 and the lower plate 14. A plurality of ducts 18 are in each case formed by the intermediate plate 16 between the upper plate 12 and the intermediate plate 16, on the one hand, and between the lower plate 14 and the intermediate plate 16, on the other hand.

The intermediate plate 16 does not run completely over the entire length of the upper plate 12 or the lower plate 14. The intermediate plate 16 is of somewhat shorter configuration, so as to form regions in which no ducts 18 are formed. In one region, an inlet 20 is arranged, so as to form an inflow region 22 in which the flow of the fluid introduced can be equalized. Correspondingly, at the opposite end of the absorber 10, an outlet 24 is provided which is arranged in an outflow region 26.

In the exemplary embodiment illustrated, both the inlet 20 and the outlet 24 are formed by the upper plate 12 and point upward. In principle, the inlet 20 and/or the outlet 24 may also be formed by the lower plate 14 and point downward. It is possible, furthermore, that the inlet 20 and the outlet 24 are arranged laterally.

The inlet 20 and/or the outlet 24 are/is preferably produced by deep drawing and formed as (a) simple protuberance(s). If appropriate, before the deep drawing, an orifice may be stamped into the upper plate or the lower plate.

In the exemplary embodiment illustrated, both the upper plate 12 and the lower plate 14 have a completely peripheral extension 28, via which the upper plate 12 is connected to the lower plate 14, for example by adhesive bonding, soldering or welding. In particular, it is possible to avoid copper or copper-containing materials in the upper plate 12, the lower plate 14 and the intermediate plate 16 and, instead, to use steel or a copper-free nonferrous metal.

The connection of the upper plate 12 to the lower plate 14 or of the upper plate 12 to the intermediate plate 16 or of the intermediate plate 16 to the lower plate 14 may take place by means of a positive connection (FIG. 2). For this purpose, for example, a snap connection 30 is provided. The snap connection 30 may have a rib 32 which is produced, in particular, by deep drawing and which has undercuts 34. The undercut rib 32 engages into a depression 36 of the lower plate 16, 14. The depression 36 tapers in an opening region facing the undercut rib 32, so that the undercut rib 32 can be reliably received by the depression 36. The depression 36 may be formed, in particular, by ribs 38 which are shaped according to the undercut rib 32 and which may likewise be produced by deep drawing. The connection 30 affords reliable fastening which can in this case be managed in a simple way during assembly.

A plurality of absorbers 10 may be connected together to form a larger solar heating plant 40 (FIG. 3). The solar heating plant 40 has fastening rails 42 which via a groove can receive the absorber 10 in the region of the peripheral extensions 28. The fastening rails 42 have a head part 44 which can be connected to a foot part 46. Furthermore, the head part 44 may have a cap in order to protect the connection against rainwater. The fastening rail 42 has in the region of the head part 44 a top side 48 which is in alignment with the upper plate 12 in order to give rise to a pleasing overall visual impression. The holding groove of the fastening device 40 has with respect to a ground 50, which, for example, may be the substructure of a building roof, a height such that a gap 52 is formed between the lower plate 14 and the ground 50. The gap 52 has a height which is sufficient to be able to lay beneath the absorbers 10 delivery pipes which can be connected to the inlet 20 and/or to the outlet 24.

The lower plate 14 illustrated in FIG. 4 has a multiplicity of conduction means which are designed as flow guide plates 54, with the result that the need for the intermediate plate 16 can be avoided. The flow guide plates 54 are formed by deep drawing out of a conduction bottom 56 to an extent such that their surfaces facing the upper plate 12, not illustrated, are level with the flange surfaces of the extension 28. The upper plate 12 can thereby be shaped as a simple panel which does not have to be subjected to a forming process. In the exemplary embodiment illustrated, the inlet 20 is formed in an entry basin bottom 58 of an entry basin 60. The width of the entry basin 60 in the flow direction defines the inflow region 22. Correspondingly, the outlet 24 is formed in an exit basin bottom 62 of an exit basin 64, the width of the exit basin 64 in the flow direction defining the outflow region 26.

Between the inflow region 22 and the outflow region 26, essentially linear, that is to say straight flow lines 66 (FIG. 5) are obtained with the aid of the flow guide plates 54. The flow lines 66 deviate from the linear flow direction solely in the region of the entry basin 60 and of the exit basin 64. The lower plate 14 is, in particular, configured symmetrically to an axis of symmetry 68.

1. An absorber for the recovery of heat from solar heating, comprising:
an upper plate (12) facing the sun,
a lower plate (14) facing away from the sun, and
conduction means (18, 54), formed between the upper plate (12) and the lower plate (14), for the essentially linear and/or homogeneous conduction of a fluid through from an inlet (20) to an outlet (24), the inlet (20) and/or the outlet (24) being formed by the upper plate (12) and/or the lower plate (14), and
the inlet (20) and/or the outlet (24) and/or the conduction means (18, 54) being capable of being produced by deep drawing.

2. The absorber as claimed in claim 1, wherein the conduction means (18, 54) are formed by the upper plate (12) and/or the lower plate (14), in particular by deep drawing.

3. The absorber as claimed in claim 1, wherein the conduction means (18, 54) are formed in one piece with the upper plate (12) and the lower plate (14) bears on the conduction means (18, 54), and/or the conduction means (18, 54) are formed in one piece with the lower plate (14) and the upper plate (12) bears on the conduction means (18, 54).

4. The absorber as claimed in claim 1, wherein a plurality of conduction means (54) are provided which are spaced apart from one another in the flow direction and/or transversely to the flow direction and which are contoured fluidically in the flow direction and, in particular, have a length in the flow direction which is greater than a width transversely to the flow direction.

5. The absorber as claimed in claim 1, wherein the lower plate (14) has an entry basin (60), assigned to the inlet (20), for forming an inflow region (22), an exit basin (64), assigned to the outlet (24), for forming an outflow region (26), and a conduction bottom (56), via which the entry basin (60) and the exit basin (64) are connected to one another, the conduction bottom (56) being at a shorter distance from the upper plate (12) than an entry basin bottom (58) of the entry basin (60) and an exit basin bottom (62) of the exit basin (64).

6. The absorber as claimed in claim 1, wherein the absorber is formed only by the upper plate (12) and the lower plate (14) and, if appropriate, a connection means for connecting the upper plate (12) to the lower plate (14).

7. The absorber as claimed in claim 1, wherein the inlet (20) and/or the outlet (24) are/is designed as (a) protuberance(s) of the upper plate (12) and/or of the lower plate (14).

8. The absorber as claimed in claim 1, wherein a positive connection is provided between the upper plate (12)/lower plate (14) and/or the upper plate (12)/intermediate plate (16) and/or the intermediate plate (16)/lower plate (14), the connection taking place, in particular, via an undercut rib (32), which is inserted in a depression (36) tapering in the opening region.

9. The absorber as claimed in claim 1, wherein the upper plate (12) and the lower plate (14) have in each case a preferably peripheral extension (28), and the upper plate (12) and lower plate (14) are connected to one another via the extension (28), in particular by adhesive bonding or laser welding.

10. A method for producing an absorber (10) for the recovery of heat from solar heating of claim 1, comprising:
provision of a first sheet bar and of a second sheet bar which have been obtained, in particular, by stamping out of one common flat strip,
deep drawing of the first sheet bar to form an upper plate (12) and/or of the second sheet bar to form a lower plate (14), during deep drawing an inlet (20) and/or an outlet (24) and/or conduction means (18, 54) being formed in the upper plate (12) and/or in the lower plate (14), and
connection of the upper plate (12) to the lower plate (14) in order to form the absorber (10).
